(19) United States
(12) Patent Application Publication
(10) Pub. No.: US 2007/0029890 A1
(43) Pub. Date: Feb. 8, 2007

(54) Salient pole electrical machine

(75) Inventors: Rajesh Pranay Deodhar, Newhaven (GB); Shinichiro Iwasaki, Hove (GB)

Correspondence Address: SUGHRUE MION, PLLC, 2100 PENNSYLVANIA AVENUE, N.W., SUITE 800, WASHINGTON, DC, 20037, US

(73) Assignee: AISIN SEIKI KABUSHIKI KAISHA

(21) Appl. No.: 11/497,315

(22) Filed: Aug. 2, 2006

(30) Foreign Application Priority Data
Aug. 3, 2005 (GB) 0515983.5

(51) Int. Cl. H02K 1/00

(52) U.S. Cl. 310/216

(57) ABSTRACT

The salient pole electrical machine comprises a salient pole passive rotor and a stator. Each slot of the stator has a winding about a permanent magnet which extends radially through the stator. The permanent magnet is polarised circumferentially. A housing of conductive material encompasses the stator. The housing has zones, adjacent the magnets, in which the material of the housing is reduced compared to zones intermediate the magnets.

### CROSS REFERENCE TO RELATED APPLICATIONS

This application is based on and claims priority under 35 U.S.C. § 119 to GB Patent Application number 0515983.5, filed on Aug. 3, 2005, the entire content of which is incorporated herein by reference.

### FIELD OF THE INVENTION

The present invention relates to salient pole electrical machines. The invention may be applied to motors and to generators. The present invention is discussed, for convenience, in relation to electric motors. However the invention is not limited to electric motors.

### BACKGROUND

It is known to house the armature of a salient pole motor in a housing which encompasses the stator thereof. It is known to form a housing of, for example, nylon or a non-magnetic material such as aluminium. The housing protects and strengthens the stator. In the paper “Switching flux permanent magnet polyphased synchronous machines” by Emmanual HOANG, Abdel Hamid BEN AHMED and Jean LUCIDARME, published in the EPE'97 conference proceedings, pages 3.903 to 3.908, 1997 there is described a three phase salient pole motor. Referring to FIGS. 1 and 2 of the accompanying drawing the motor is a three phase machine having a salient pole rotor 1 having ten salient poles 3 and a stator 5 having twelve slots. The stator 5 shown in FIGS. 1 and 2 comprises an armature in which permanent magnets 9 extends radially through the armature. The permanent magnets 9 are polarised circumferentially as indicated by arrow 11. Armature windings (not shown) occupy slots 7 in the armature. As indicated in FIG. 1 adjacent magnets 9 are oppositely polarised. The armature windings are connected in three phases as described in the paper.

The present inventors have found through experimentation that if a motor of the type shown in FIGS. 1 and 2 is housed in a housing 10′ of conductive material then there are energy losses due to the presence of conductive material of the housing.

### SUMMARY OF THE INVENTION

According to the present invention there is provided a salient pole electrical machine comprising: a salient pole passive rotor; a stator, the stator comprising, for each slot thereof, a winding about a permanent magnet which is polarised circumferentially, the magnet extending radially through the stator; and a housing of conductive material encompassing the stator, the housing having zones, adjacent the magnets in which the material of the housing is reduced compared to zones intermediate the magnets.

### BRIEF DESCRIPTION OF THE DRAWINGS

FIG. 1 is a front cross-section of a known three phase salient pole motor;

FIG. 2 is an axial cross-section of the motor of FIG. 1;

FIG. 3 is a front cross-section of the rotor and stator of a motor in accordance with an embodiment of the present invention;

FIG. 4 is an axial cross-section of the motor of FIG. 3;

FIG. 5 is a diagrammatic representation of the housing of the motor of FIGS. 3 and 4;

FIG. 6 is a graph showing power loss against rotational speed for an example of the motor of FIGS. 3 and 4 compared with comparative examples;

FIG. 7 is a front cross-sectional view of another motor of the present invention;

FIG. 8 is an axial cross-section of the motor of FIG. 7;

FIG. 9 is a cross-sectional view of another motor in accordance with the invention; and

FIG. 10 is a schematic block diagram of a motor in combination with an inverter.

FIG. 11 is a diagrammatic representation showing magnetic flux in zones adjacent the radially outer ends of the permanent magnets.

FIG. 12 is a graph showing the stator outside leakage flux density variation.

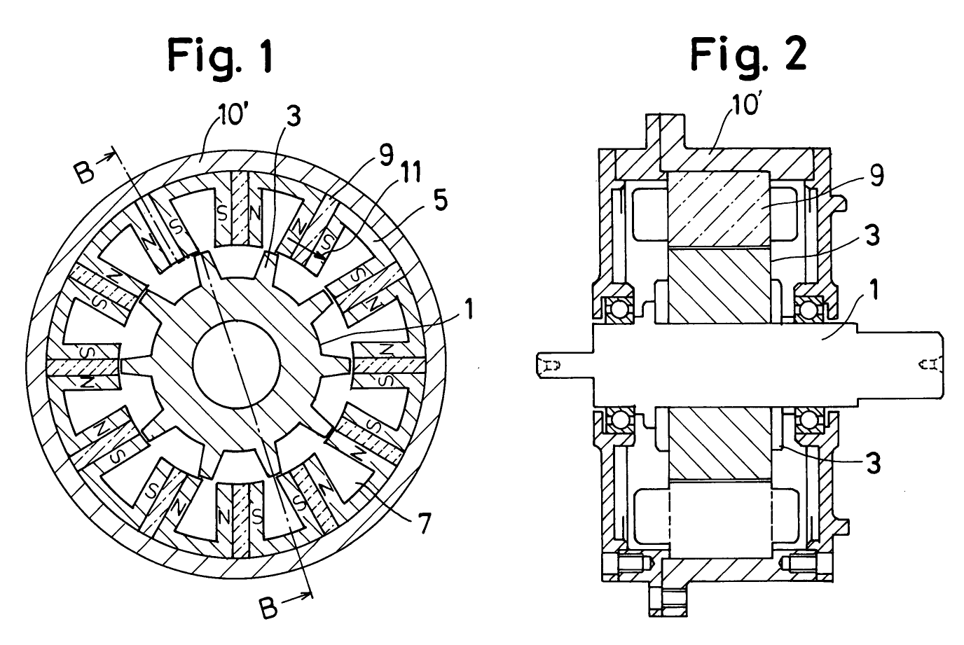

### DETAILED DESCRIPTION

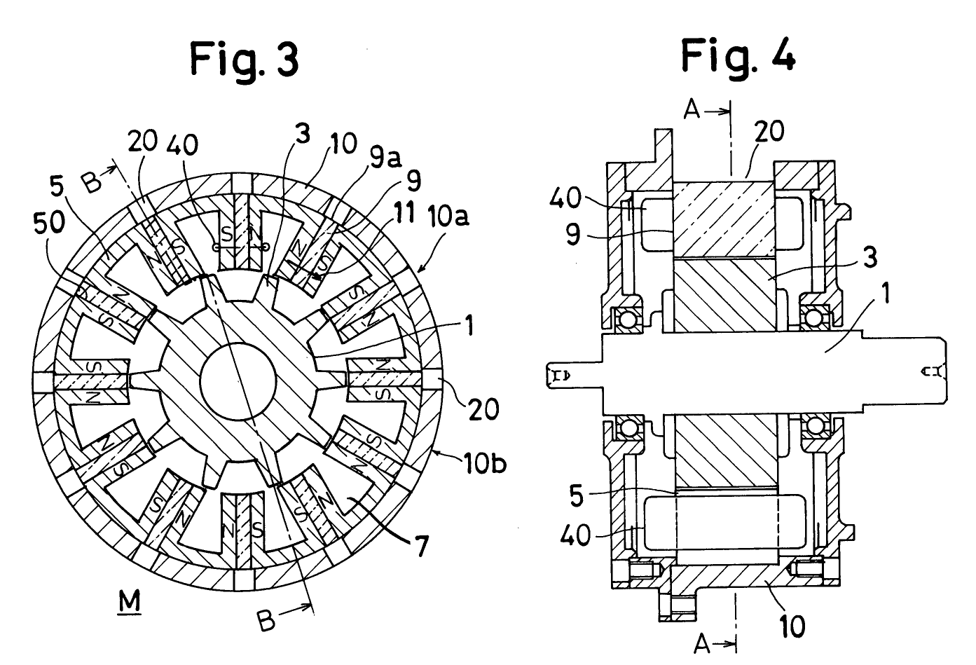

Referring to FIG. 3 an example of a motor M of the present invention comprises a passive rotor 1 having 10 salient poles rotatable within a stator 5 having 12 slots. The motor M is a three phase motor.

Each slot of the stator 5 comprises a permanent magnet 9 which extends radially through the stator but which is polarised circumferentially as indicated by arrow 11. A winding 40 is winding about the permanent magnet 9.

For further details of the structure of the motor M reference is invited to the paper mentioned above.

The inventors have discovered that flux leaks from the stator 5 at the radially outer ends 9a of the permanent magnets 9. The flux varies with frequency of rotation of the rotor. Thus the flux varies with speed of rotation of the rotor and thus with frequency of operation of the motor.

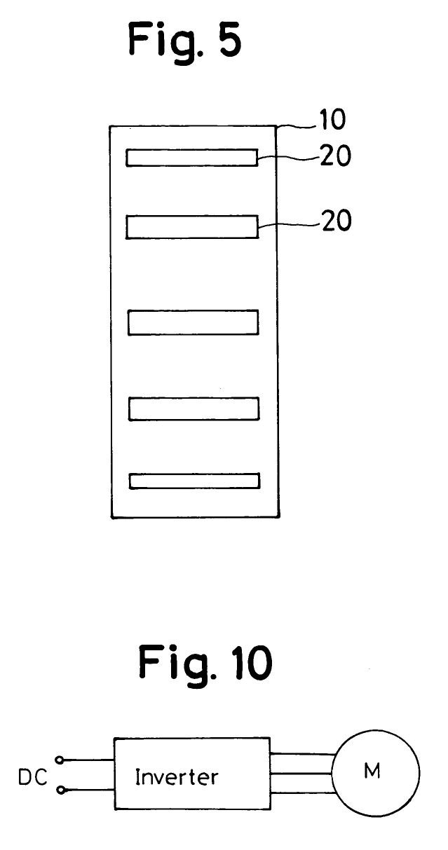

FIG. 5 illustrates, by way of example, an aluminium housing 10 which is used with the motor M of FIG. 3 in accordance with the present invention.

The housing comprises a cylindrical aluminium member in which are cut slots 20, also referred to as openings, which in this example extend radially through the housing. There is one slot or opening 20 positioned adjacent zone 10a the end 9a of each permanent magnet 9. The material in the adjacent zone 10a of the housing 10 is reduced compared to the zones 10b intermediate the magnets 9.

FIGS. 3 and 4 show the combination of the housing 10 and the motor M with the slots or openings 20 positioned at the radially outer ends 9a of the magnets 9.

Each slot is dimensioned to be open over a major proportion of the length of the permanent magnet in a direction parallel to the rotational axis of the rotor. Each slot extends circumferentially over a distance occupied by a major proportion of the leakage flux from the permanent magnets.

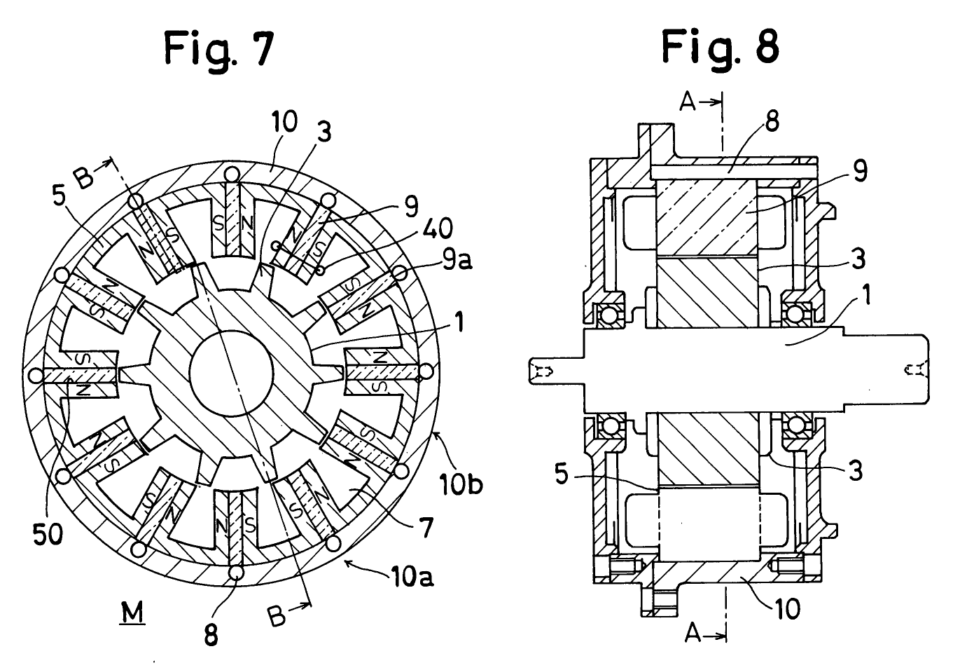

Referring to FIGS. 7 and 8 there is shown in cross-section the stator 5 having permanent magnets 9 extending radially therethrough and surrounded by the housing 10. In this example of the present invention, the material of the housing is reduced adjacent zone 10a the end 9a of each magnet 9 by provision of a bore 8 in the housing 10. The bore extends parallel to the axis of rotation of the rotor 2. The bore 8 is formed, for example, simply by drilling the housing 10. The material in the adjacent zone 10a of the housing 10 is reduced compared to the zones 10b intermediate the magnets 9.

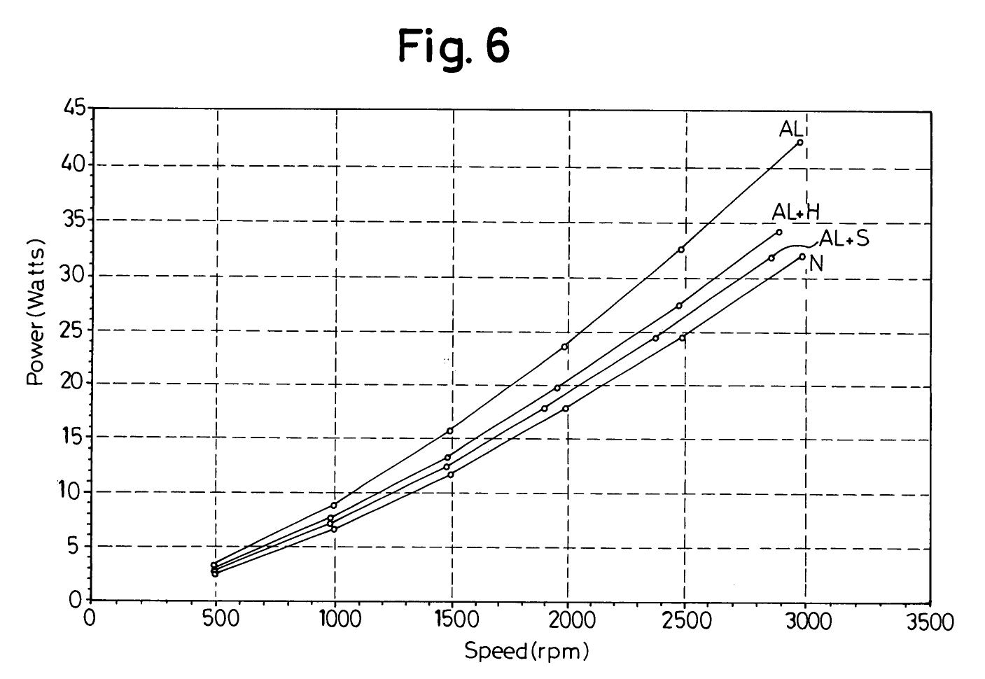

Referring to accompanying graph FIG. 6, FIG. 6 shows on the vertical axis power loss in watts and along the horizontal axis speed of rotation of the rotor in rpm. Curve Al shows the loss when the motor is housed in an aluminium housing having no material reduction adjacent the permanent magnets. Curve N shows the losses if the motor is housed in a housing of nylon. Curve Al+H shows the loss when holes or bores 8 are formed in the housing as shown in FIG. 7. Curve Al+S shows the losses when using the housing having slots as shown in FIG. 4.

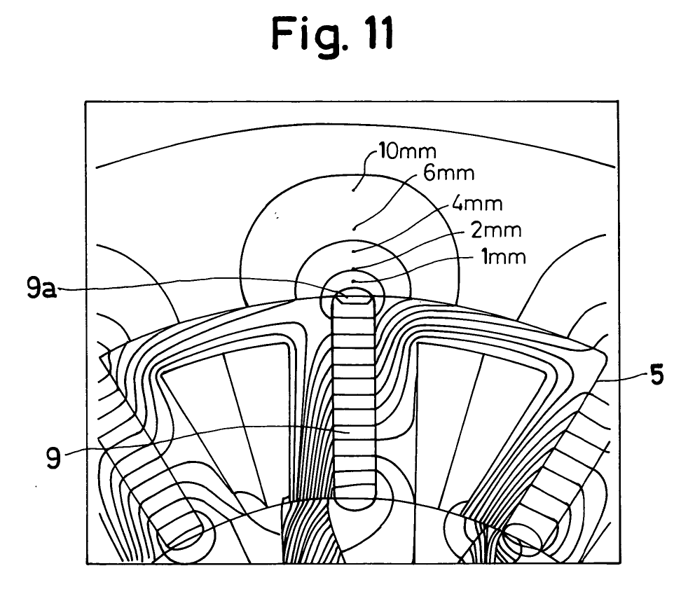

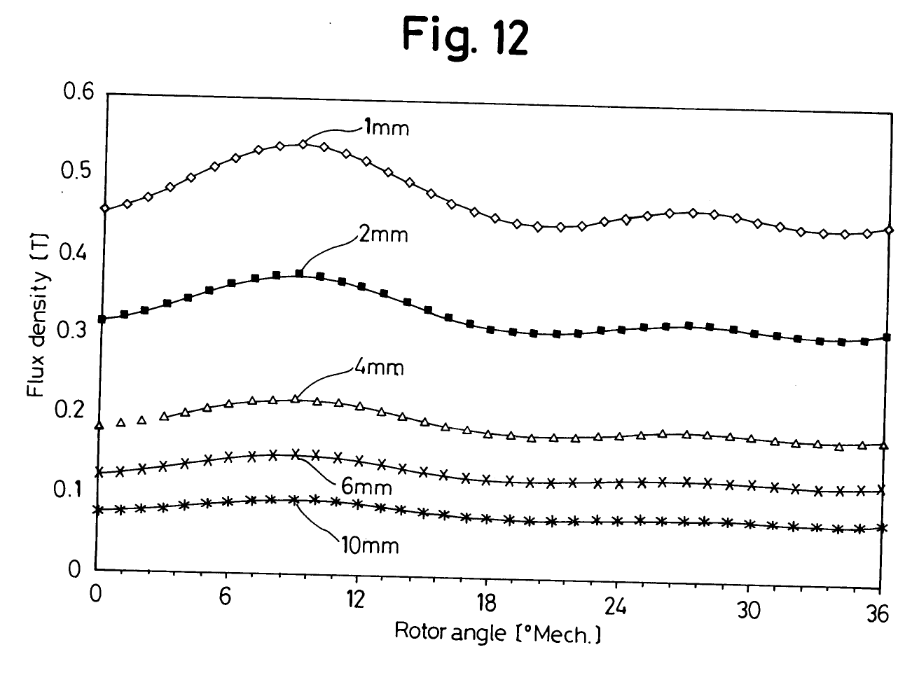

Referring to FIG. 11 and accompanying graph FIG. 12, FIG. 11 shows magnetic flux in zones adjacent the radially outer ends 9a of the permanent magnets 9 and FIG. 12 shows the stator outside leakage flux density variation with the rotor 1 angle and distance from the stator 5.

According to FIG. 11 and FIG. 12, the large variation of flux density occurs at small distance away from the stator 5, for example, 1 mm, which causes large eddy currents to be induced in the housing 10.

On the other hand, the small variation of flux density occurs at large distance away from the stator 5, for example, 10 mm, which causes small eddy currents to be induced in the housing 10.

Therefore, the slots 20 in the housing 10 as shown in FIG. 4, or the holes 8 in the housing 10 as shown in FIG. 7 removes the material at an appropriate location of the housing 10 and reduces the eddy currents and, accordingly, the eddy current loss.

The motor used for the purpose of deriving the graphs in FIG. 6 is the motor shown in FIGS. 3 and 4 and FIGS. 7 and 8 having 10 salient poles on the rotor and 12 slots on the stator and operating in three phases.

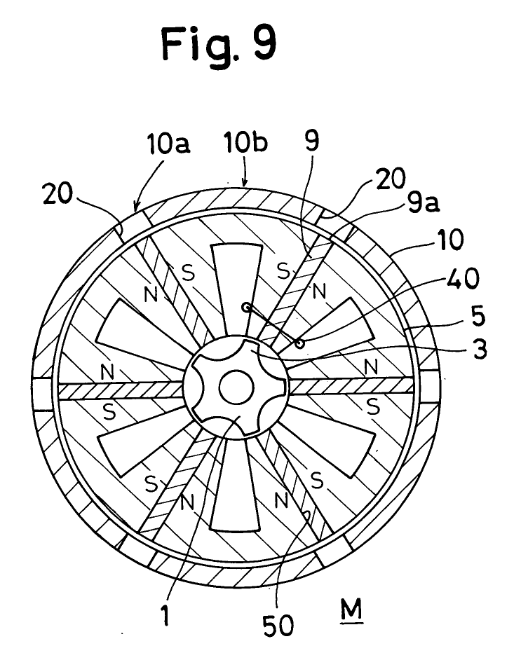

Referring to FIG. 9, there is shown in cross-section the stator 5, rotor 1 and housing 10 of another motor M in accordance with the invention. This motor M has 5 salient poles 3 on the rotor and 6 slots on the stator 4, and operates in three phases. In this machine the housing 10 has slots 20 therein as described above. Alternatively it may have bores 8 as described above.

A salient pole machine having five salient poles on the rotor and six slots on the stator and operating in three phases is considered to be inventive per se and is the subject of co-pending and co-filed patent application attorney reference P022669GB and filed on the same day as the present application. However, the present invention is not limited to a machine having any particular number of salient poles on the rotor and slots on the stator.

The housing 10 of the motors M of FIGS. 3 to 9 as described above is of non-magnetic material, in this example aluminium. However the housing 10 of the motors M of FIGS. 3 to 9 having slots may be of magnetic material, for example steel.

FIG. 10 is a schematic block diagram showing a motor M which is as described above, the stator of which is energised by a three phase inverter I in the known manner.

Whilst the invention has been described by way of example to three phase machines, it may be applied to machines of other numbers of phases.

Whilst the invention has been described by way of example to a motor, the invention is also applicable to corresponding generators.

According to the present invention there is provided a salient pole electrical machine comprising: a salient pole passive rotor; a stator, the stator comprising, for each slot thereof, a winding about a permanent magnet which is polarised circumferentially, the magnet extending radially through the stator; and a housing of conductive material encompassing the stator, the housing having zones, adjacent the magnets in which the material of the housing is reduced compared to zones intermediate the magnets.

In one embodiment of the invention, the machine comprises the salient pole passive rotor, stator, and the housing which is made of conductive material and encompasses the stator, wherein the stator has a number of slots, a number of magnets extending radially through the slots and being polarized circumferentially, and a winding about the magnets, wherein the housing has zones, adjacent the magnets, in which the material of the housing is reduced compared to zones intermediate the magnets.

The inventors have found that the losses are due to eddy currents induced in the conductive housing. These eddy currents are induced in the housing in zones adjacent the radially outer ends of the permanent magnets.

By reducing the material of the housing in those zones the eddy currents are reduced, reducing the losses.

In one embodiment of the invention, openings, or slots, are cut through the housing in the zones adjacent the permanent magnets. In another embodiment bores are formed in the housing adjacent the permanent magnets. The bores are, for example, parallel to the axis of rotation of the rotor.

Aluminium is used for the housing of a salient pole machine because it is non-magnetic. However, it has been found that with the present invention, especially in the version in which slots are cut in the housing, the housing may be of magnetic material for example steel which is cheaper and stronger than aluminium.

It has been found that the losses due to the eddy currents increase with rotational speed of the rotor and thus frequency of operation of the motor.

An example of the invention is a three phase machine having 12 slots 50 and 10 poles. Another example of the invention, for operation at high speed, is a three phase machine comprising a rotor having five salient poles and a stator having six slots 50.

However, the invention is not limited to three phase machines it may be applied to any number of phases. The invention is not limited to particular numbers of slots and poles.

1. A salient pole electrical machine comprising: a salient pole passive rotor; a stator, the stator comprising, for each slot thereof, a winding about a permanent magnet which is polarised circumferentially, the magnet extending radially through the stator; and a housing of conductive material encompassing the stator, the housing having zones, adjacent the magnets, in which the material of the housing is reduced compared to zones intermediate the magnets.

2. A salient pole electrical machine according to claim 1, wherein the machine comprises the salient pole passive rotor, stator, and the housing which is made of conductive material and encompasses the stator, wherein the stator has a number of slots, a number of magnets extending radially through the slots and being polarized circumferentially, and a winding about the magnets, wherein the housing has zones, adjacent the magnets, in which the material of the housing is reduced compared to zones intermediate the magnets.

3. A salient pole electrical machine according to claim 1, wherein the housing has openings at the said zones adjacent the magnets.

4. A salient pole electrical machine according to claim 1, wherein the housing has bores at the said zones adjacent the magnets, the bores extending parallel to the axis of rotation of the rotor.

5. A salient pole electrical machine according to claim 1, wherein the housing has openings at said zones adjacent the magnets, which openings extend radially.

6. A salient pole electrical machine according to claim 5, wherein the housing is made of magnetic material.

7. A salient pole electrical machine according to claim 6, wherein the housing is made of steel.

8. A salient pole electrical machine according to claim 1, wherein the housing is made of non-magnetic material.

9. A salient pole electrical machine according to claim 8 wherein the housing is made of aluminium.

10. A salient pole electrical machine according to claim 1 wherein the machine is a three phase machine, and the rotor has five salient poles and the stator has six slots.

11. A salient pole electrical machine according to claim 1, wherein the machine is a motor.

12. A salient pole electrical machine according to claim 1, wherein the machine is a generator.

13. A salient pole electrical machine according to claim 11, further comprising a portion for energising the stator.
